(19) United States
(12) Patent Application Publication
(10) Pub. No.: US 2018/0268945 A1
(43) Pub. Date: Sep. 20, 2018

(54) MAGNETOCOMPRESSION-ASSISTED FUSION

(71) Applicant: 1994680 ALBERTA LTD., Calgary (CA)

(72) Inventors: Christopher Robert JAMES, Calgary (CA); John Edward LONG, Calgary (CA); Dwight Edward MANNING, Calgary (CA)

(73) Assignee: 1994680 ALBERTA LTD., Calgary, AB (CA)

(21) Appl. No.: 15/761,953

(22) PCT Filed: Sep. 22, 2016
(86) PCT No.: PCT/CA2016/051116

§ 371 Date: Mar. 21, 2018

Related U.S. Application Data
(60) Provisional application No. 62/222,107, filed on Sep. 22, 2015.

(51) Int. Cl. G21B 1/05; H05H 1/10

(52) U.S. Cl. CPC G21B 1/05; H05H 1/10

(57) ABSTRACT

A method for facilitating fusion by magnetocompression of hydrogen isotopes. A magnetic field of at least 10⁵ T is exposed to fuel including hydrogen isotopes. After exposure to the magnetic field, the fuel is energized by a laser, ionizing the hydrogen and converting the fuel to plasma. The magnetic field compresses internuclear separation of H₂+. The magnetic field also compresses the electron radius of hydrogen atoms, resulting in increased electron binding energy. Each of these changes accompanying magnetocompression facilitates fusion of the nuclei following laser excitation. A solenoid for enhancing magnetic fields is also described. The solenoid includes conduction member defining a cavity therein. The conduction member is a highly conductive material, which may include a composite of a semiconductor and a conductor. The solenoid may be applied to hold the fuel or in any application to concentrate the magnetic field in a small volume.

### CROSS-REFERENCE TO RELATED APPLICATIONS

This application claims the benefit of priority of U.S. Provisional Patent Application No. 62/222,107, filed Sep. 22, 2015, which is hereby incorporated by reference.

### FIELD

The present disclosure relates generally to magnetocompression of atoms to facilitate fusion.

### BACKGROUND

Controlled fusion of deuterium into helium, or of deuterium and tritium into helium and a free neutron for energy production has been a goal of the scientific community for decades. Controlled fusion would provide large amounts of energy for relatively inexpensive input costs in terms of fuel. Inertial confinement fusion and magnetized linear inertial fusion each use lasers to ionize the deuterium and tritium, and convert the resulting ionized material to plasma. Sufficient compression of the plasma may allow a sustainable and continuous fusion reaction.

With the current serious climate change and other environmental concerns resulting from carbon emissions associated with human energy generation by fossil fuels, the value of controlled fusion for energy production increases.

### SUMMARY

Inertial confinement fusion and magnetized linear inertial fusion each suffer from practical drawbacks. Current approaches to inertial confinement fusion suffer from inefficiencies, including energy loss when electrons resulting from ionization of hydrogen isotope fuel absorb energy from a laser used to convert the fuel into plasma. Magnetized linear fusion suffers from a similar drawback. It is, therefore, desirable to provide an improved approach to facilitating fusion for energy production.

It is an object of the present disclosure to mitigate at least one disadvantage of previous approaches to facilitating fusion for energy production. An atom may be compressed by a magnetic field, resulting in less separation between electrons and the nucleus, with a corresponding increase in binding energy of electrons in the atom. In addition, where the atom is part of a molecule, interatomic bonds are also compressed. Modelling studies of H₂⁺ have indicated that magnetocompression of a target material (e.g. deuterium, deuterium and tritium, etc.) prior to ionization and conversion of the target material to plasma may facilitate fusion. Application of a strong magnetic field would precede ionization and conversion of the target material to plasma by laser ignition similarly to the laser ignition used in inertial confinement fusion or magnetized linear inertial fusion. The modelling results were obtained by applying an amended Bohr model to model a hydrogen atom, a deuterium atom, a tritium atom, and H₂⁺. The modelling results are consistent with previous amended Bohr and quantum mechanical models of a hydrogen atom by V. Canuto and D. C. Kelly [1] and a quantum mechanical model of a hydrogen atom by A. K. Aringazin [2].

The modelling studies support two bases for facilitation of fusion by magnetocompression. First, the molecular compression reduces the amount of compression which a laser following magnetocompression must provide to compress the molecules to the point where smaller interatomic separation increases the likelihood that the atoms will interact at a range in which coulombic interactions are overcome and other mechanisms such as quantum tunneling facilitate nuclear interactions. Second, an increase in binding energy of electrons in the sample, delaying ionization prior to plasma formation. The delay in ionization allows the laser to be exposed to a greater portion of the fuel before a field of free electrons forms and reflects the laser's energy. The delay in ionization facilitates more compression and plasma conversion by the laser before an electron field forms and reflects the laser's energy.

Based on the modelling results, a magnetic field of about 2×10⁶ T results in H₂⁺ molecules being compressed by a factor of over 15 in terms of comparative volume (V_{c} below) relative to in the absence of the magnetic field. Put otherwise, the separation between the two protons (dₙ below), and between either proton and the electron (rₑₙ below) were each greater in the absence of the 2×10⁶ T field by a factor of 2.500. The binding energy of the compressed atom's electron increases relative to that observed in the absence of the magnetic field. This increase in electron binding energy mitigates electron shielding associated with laser-induced excitation and the energy losses which accompany such shielding. The modelling results show that the binding energy of the ground state electron is increased by a factor of 2.4.

A magnetic field with a strength of 2×10⁶ T cannot be generated with current tokamak or other magnetic field sources as these sources are currently configured. The planned International Thermonuclear Experimental Reactor will provide more than enough energy to create this field in a 5 mm³ volume and would be a reasonable source of energy once engineering challenges related to concentrating this energy into the small area are overcome. In addition, energy sources planned to be used for magnetized liner inertial fusion provide sufficient energy to generate a magnetic field on the order of 10⁶ T.

To facilitate concentrating a strong magnetic field in a very small volume, a solenoid is provided. The solenoid includes a conduction member coiled about and extending along a longitudinal axis. A cavity is defined within coils of the conduction member for receiving fusion fuel, or any target for a strong magnetic field, within the solenoid. For facilitating fusion, the cavity may have a volume of about 5 mm³ to facilitate concentrating input energy into a small volume for concentrating magnetic field density within the solenoid. However, the solenoid has applications outside of facilitating fusion, such as in miniaturized systems for information-containing media, power circuits, transformers, or control systems. The solenoid could be used in any industry or application where concentrating a magnetic field in a small volume has advantages.

The conduction member of the solenoid may be prepared from a composite material. The composite material may include a conductor material and an semiconductor material, resulting in a highly conductive material. The conductor material may include copper, gold, silver, germanium, aluminum, tungsten, titanium, or other suitable metals or nonmetals. The semiconductor material may include a brushed forest of carbon nanotubes, gallium arsenide, cuprate-perovskite ceramics, or other suitable semiconductor materials. The solenoid may include a body within the conduction member, with the body being prepared from an insulative material.

In operation, the solenoid is exposed to an electrical field, resulting in a strong magnetic field directed inwards from the conduction member into the cavity, concentrating the magnetic field within the cavity. The solenoid may be used as a single piece or a series of progressively larger solenoids may be positioned concentrically around one another to further concentrate the magnetic field within an innermost solenoid. In a concentric series of solenoids, the conduction members may each have the same thickness value and may be separated by integer values of the thickness value.

In a first aspect, the present disclosure provides a method for facilitating fusion by magnetocompression of hydrogen isotopes. A magnetic field of at least 10⁵ T is exposed to fuel including hydrogen isotopes. After exposure to the magnetic field, the fuel is energized by a laser, ionizing the hydrogen and converting the fuel to plasma. The magnetic field compresses internuclear separation of H₂⁺. The magnetic field also compresses the electron radius of hydrogen atoms, resulting in increased electron binding energy. Each of these changes accompanying magnetocompression facilitates fusion of the nuclei following laser excitation. A solenoid for enhancing magnetic fields is also described. The solenoid includes conduction member defining a cavity therein. The conduction member is a highly conductive material, which may include a composite of a semiconductor and a conductor. The solenoid may be applied to hold the fuel or in any application to concentrate the magnetic field in a small volume.

In a further aspect, the present disclosure provides a method of facilitating fusion comprising: providing a fuel comprising at least one fusion isotope; applying a compressive magnetic field having a field strength of at least 105 T to the fuel to compress the fuel, resulting in a compressed fuel having an increased electron binding energy of the fusion isotope by a factor of at least 1.04 and an increased molecular density of the fusion isotope by a factor of at least 1.14; and applying a laser to the compressed fuel to excite the fusion isotope and transition the fuel to plasma, facilitating fusion between nuclei of the fusion isotope.

In some embodiments, the compressive magnetic field has a strength of at least 4.7×10⁵ T. In some embodiments, the compressive magnetic field has a strength of at least 1×10⁶ T. In some embodiments, the compressive magnetic field has a strength of about 2×10⁶ T.

In some embodiments, the at least one fusion isotope comprises at least one hydrogen isotope. In some embodiments, the at least one hydrogen isotope comprises deuterium. In some embodiments, the at least one hydrogen isotope comprises tritium.

In some embodiments, applying the compressive magnetic field takes place for between about 0.01 ns and about 10 ns.

In some embodiments, applying the laser takes place for about 10 ns.

In some embodiments, applying the compressive magnetic field continues after the onset of applying the laser to the fuel for confining the plasma.

In some embodiments, the at least one fusion isotope comprises deuterium; the compressive magnetic field has a field strength of about 4.7×10⁵ T; the increased electron binding energy is increased by a factor of about 1.4; and the increased molecular density is increased by a factor of about 3. In some embodiments, the at least one fusion isotope further comprises tritium.

In some embodiments, the at least one fusion isotope comprises deuterium; the compressive magnetic field has a field strength of about 1×10⁶ T; the increased electron binding energy is increased by a factor of about 1.8; and the increased molecular density is increased by a factor of about 7. In some embodiments, the at least one fusion isotope further comprises tritium.

In some embodiments, the at least one fusion isotope comprises deuterium; the compressive magnetic field has a field strength of about 2×10⁶ T; the increased electron binding energy is increased by a factor of about 2.4; and the increased molecular density is increased by a factor of about 16. In some embodiments, the at least one fusion isotope further comprises tritium.

In some embodiments, the compressed fuel has an electron radius on the order of 10⁻¹¹ m.

In some embodiments, the fuel comprises about 5 mm³ of solid deuterium contained in a first solenoid. In some embodiments, the first solenoid comprises a conductive member coiled around the fuel for localizing the compressive magnetic field. In some embodiments, the conductive member comprises a composite material, the composite material including a conductor material and a semiconductor material. In some embodiments, the conductor material comprises a metal and the semiconductor material comprises carbon nanotubes. In some embodiments, the metal comprises copper and the composite material comprises copper bonded on the carbon nanotubes.

In some embodiments, the fuel comprises about 5 mm³ of solid deuterium contained in a first solenoid. In some embodiments, the first solenoid is received within a second solenoid; each of the first solenoid and the second solenoid has a thickness extending radially with respect to a common longitudinal axis of the two solenoids, the thickness having a value of λ; and the first solenoid is separated from the second solenoid by an integer value of λ.

In a further aspect, the present disclosure provides a solenoid for enhancing a magnetic field within the solenoid, the solenoid comprising: a conduction member extending along a longitudinal axis, the conduction member having a thickness extending radially with respect to the longitudinal axis, the thickness having a value of λ; and a cavity defined within the conduction member, the cavity extending along the longitudinal axis for receiving a target material; wherein the conduction member comprises a conductor material and a semi-conductor material for providing a highly conductive composite material.

In some embodiments, the conduction member is coiled about the longitudinal axis. In some embodiments, the conduction member is coiled about the longitudinal axis in a helical pattern around the longitudinal axis.

In some embodiments, wherein the conduction member comprises a series of plates in communication with each other through a conduction linker. In some embodiments, wherein the value of λ is at least 10 times greater than a dimension of the plates extending along the longitudinal axis.

In some embodiments, the conductor material comprises copper, the semiconductor material comprises a forest of carbon nanotubes, and the composite material comprises copper bonded to the forest of carbon nanotubes

In some embodiments, the sollenoid includes an insulative body within the conduction member, the insulative body electrically insulating the cavity from the conduction member.

In some embodiments, for a selected value of magnetic field density B_{z}(0),

$$λ = 1.989 {( 10 )}^{- 8} {J}_{0} ( ω \sqrt{μɛ} \frac{d}{2} ) {B}_{z} ( 0 ) .$$

In a further aspect, the present disclosure provides a system comprising at least two concentrically arranged solenoids as above, wherein concentrically arranged conduction members share a common value of λ.

In some embodiments, neighbouring concentrically arranged conduction members are separated by a distance of nλ.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic of the geometry of a deuterium atom;

FIG. 2 is a schematic of the geometry of H₂⁺;

FIG. 3 is a perspective view schematic of a solenoid;

FIG. 4 is an elevation view of the solenoid of FIG. 3 down a longitudinal axis of the solenoid;

FIG. 5 is an elevation view of the solenoid of FIG. 3 with x, y, and z (longitudinal) axes shown;

FIG. 6 is a schematic of the solenoid of FIG. 3 including fuel inside a cavity of the solenoid;

FIG. 7 is an elevation view of the solenoid of FIG. 3 down a longitudinal axis of the solenoid and including fuel inside a cavity of the solenoid;

FIG. 8 is a perspective view schematic of a solenoid including an insulating inner body;

FIG. 9 is an elevation view of the solenoid of FIG. 8 down a longitudinal axis of the solenoid;

FIG. 10 is an elevation view of three concentric solenoids, each as shown in FIG. 4, down a common longitudinal axis the three solenoids and including fuel inside a cavity of the innermost solenoid;

FIG. 11 is an elevation view of three concentric solenoids, each as shown in FIG. 9, down a common longitudinal axis the three solenoids and including fuel inside a cavity of the innermost solenoid;

FIG. 12 is a perspective view schematic of a solenoid; and

FIG. 13 is an elevation view of the solenoid of FIG. 3 down a longitudinal axis of the solenoid.

### DETAILED DESCRIPTION

Generally, the present disclosure provides a method and system for facilitating controlled fusion. A magnetic field is applied to compress a fuel at the molecular level. The fuel would typically include hydrogen isotopes. Modelled data shows that exposure of H₂⁺ to a 2×10⁶ T magnetic field for between about 0.01 and 10 ns results in the comparative volume (V_{c} below) being compressed by a factor of over 15. The separation between the two protons (dₙ below), and between either proton and the electron (rₑₙ below) were each greater in the absence of the 2×10⁶ T field by a factor of 2.500. The binding energy of the compressed atom's electron is increased by a factor of 2.4.

The compression would facilitate fusion by reducing the level of compression which the laser must provide from a factor of about 6,000 to a factor of about 200. The increase in binding energy would facilitate fusion by delaying ionization prior to plasma formation. The delay in ionization allows the laser to be exposed to a greater portion of the fuel before a field of free electrons forms and reflects laser energy. The delay in ionization thus facilitates more compression and plasma conversion by the laser before the electron field reflects the laser power.

A fundamental barrier to be overcome for controlled nuclear fusion is coulomb repulsion between the nuclei of ionized hydrogen isotopes. Approaches applied to mitigate the repulsion include inertial confinement fusion, magnetic confinement fusion, and magnetized liner inertial fusion (“MagLIF”). Inertial confinement fusion uses lasers to heat and compress fuel. The fuel is often solid H₂ including deuterium and tritium isotopes. Isotopes of other atoms may also be applied. Magnetic confinement fusion uses a magnetic field, typically in the range of tens of Tesla over many seconds of exposure time to compress a similar fuel into plasma and confine the plasma to allow fusion events to occur. MagLIF applies a magnetic field in the range of 10³ T for tens of nanoseconds to a similar fuel inside a metal container to crush the container along one dimension prior to excitation with a laser on one end of the container, and then to confine the plasma after excitation begins. Neither of these applications apply a magnetic field of at least 10⁵ T to a hydrogen isotope fuel for a period of about 10 ns prior to excitation of the fuel with a laser to further compress and heat the fuel for conversion to plasma and further compression.

Ideally, the compression would reduce at least one spatial dimension of an atom to be of the order of the range of the nuclear force or where quantum tunneling occurs, between about 10⁻¹³ m to 10⁻¹⁵ m. Molecules compressed to this degree would give rise to nuclear fusion when in sufficiently close encounter with one another. However, to compress atoms to this degree requires an extremely large magnetic field in the range of between 10¹¹ T (i.e. the upper range of fields generated by magnetars) and 10¹⁵ T (i.e. many thousands of times greater than the upper range of fields generated by magnetars).

To characterize the strength of the magnetic field required to compress an atom to the point where at least one dimension is on the range of about 10⁻¹³ to 10⁻¹⁵ m, a simple amended Bohr theory model of a hydrogen atom presented by Canuto and Kelly [1] is used as a basis to prepare an amended Bohr theory model of H₂⁺. The amended Bohr theory model of H₂⁺ is used to expeditiously demonstrate the concept and gain an understanding of what magnetic field values would be required to compress a molecule to this point. In this model the magnetic field is assumed constant and in the z-direction. Full quantum theory models of a hydrogen atom are also presented in Canuto and Kelly [1], and in A. K. Aringazin [2]. The amended Bohr model of H₂⁺ applied herein does not include any modelling of the spatial z-dependence of the atoms resulting from the magnetic field. The full quantum presentation including the z-behavior demonstrated in Aringazin [2] shows that the electron orbit of a hydrogen atom has a toroidal configuration. In a magnetic field, because of the atomic magnetic dipole moment, the atoms will align their angular momentum quantities in the direction of the magnetic dipole moment.

As shown in detail below, the amended Bohr model of H₂⁺ predicts that the magnetic field required for reducing to the atomic radius to the 10⁻¹⁵ m range along one dimension is about 10¹⁵ T, beyond any current known field strength, and many thousand times that held in a magnetar [3]. However, the model also shows that for field strengths within the possibility of current and future technology that a singularly ionized dihydrogen molecule can be compressed, and the ground state binding energy of an atom's orbiting electron can be meaningfully increased, as a result magnetocompression. Each of these consequences of magnetocompression facilitate laser fusion process.

The amended Bohr model of H₂⁺ shows that compression of a pre-plasma precursor may facilitate the current approaches to inertial confinement laser fusion, such as those described in Biello D. [4] and Hurricane O. A. et al [5]. In MagLIF, the magnetic field is primarily limited to suppressing cross-field thermal transport, Francis Theo Y. C. [6]. In contrast, magnetocompression prior to laser excitation facilitates fusion by increasing each of the density of the target material and the binding energy of the ground state electron of hydrogen (including isotopes of hydrogen) over the field free case. The effect is expected to apply, to a lesser degree, to larger atoms which are fusion candidates.

In the modelled data, a field of 2×10⁶ T shrinks H₂⁺ by a factor of 15 and increases the ground state electron binding energy of the hydrogen atom by a factor of 2.4. At a strength of B=2×10⁶ T, a comparison can be made for the hydrogen atom with quantum mechanical results in [1]. Each of these changes induced in H₂⁺ by compression may facilitate inertial confinement laser fusion. The effects of the magnetic field on H₂⁺ which includes deuterium, tritium, or both isotopes, as opposed to hydrogen per se (i.e. one proton and one electron), would be comparable, as the magnetic field would interact with the atom through charges on the proton and the electron.

Magnetic Field Source

The International Thermonuclear Experimental Reactor (“ITER”) is planned to produce 41×10⁹ joules in a tokamak to generate a field of 11.8 T in a volume of 840 m³ for milliseconds [7]. If about 16×10⁹ joules of the energy produced in the ITER were applied to a laser inertial confinement fusion target having a volume of 5 mm³ for producing a magnetic field with a duration of about 10 ns, the field strength would be in the range of 2×10⁶ T.

A levitated shell version of the MagLIF example by D. Sinars [8] has a target yield of 4.8×10⁹ joules and a peak magnetic field of 12.5×10³ T for tens of nanoseconds. As shown below in Table 1, any change in binding energy of a hydrogen atom's electron observed at this magnetic field strength would be inconsequential. While no data below 10⁵ T is shown for the molecular density ratio values in Table 2, there would similarly be little change in molecular density at this field strength. If the energy produced in the MagLIF installation were applied to a laser inertial confinement fusion target having a 5 mm³ volume for producing a magnetic field with a duration of about 10 ns, the field strength would be in the range of about 10⁶ T.

The pulse time for the mega-Tesla field would be significantly less than that for the ITER. Currently, magnetic fields of over 90 Tesla are being nondestructively generated for a millisecond-range pulse. The mega-Tesla field used for magnetocompression prior to inertial confinement laser fusion would have a pulse duration on the order of between about 0.01 ns and about 10 ns. The timeframe for the mega-Tesla field is between ten million and one hundred thousand times less in duration than for the 90+ Tesla fields currently being generated. The mega-Tesla field is ten thousand times stronger than a hundred Tesla field. Typically, destructive effects of magnetic fields occur only after longer exposures, such as in the millisecond range. The destructive nature of mega-Tesla fields over such a short timeframe is currently unknown. In addition, as indicated above, a solution would also be required to concentrate a portion of the energy available with the planned ITER tokamak, or other energy source, into a sufficiently small volume to generate a mega-Tesla magnetic field.

The magnetic field could be generated for a duration of about 10 ns, followed by a laser pulse of about 10 ns. The laser pulse would overlap at least slightly with the magnetic field exposure. If sufficient energy is available to maintain the magnetic field beyond the onset of laser excitation, the compressive magnetic field could further act as a confinement field to confine the plasma.

Amended Bohr Model of H₂⁺

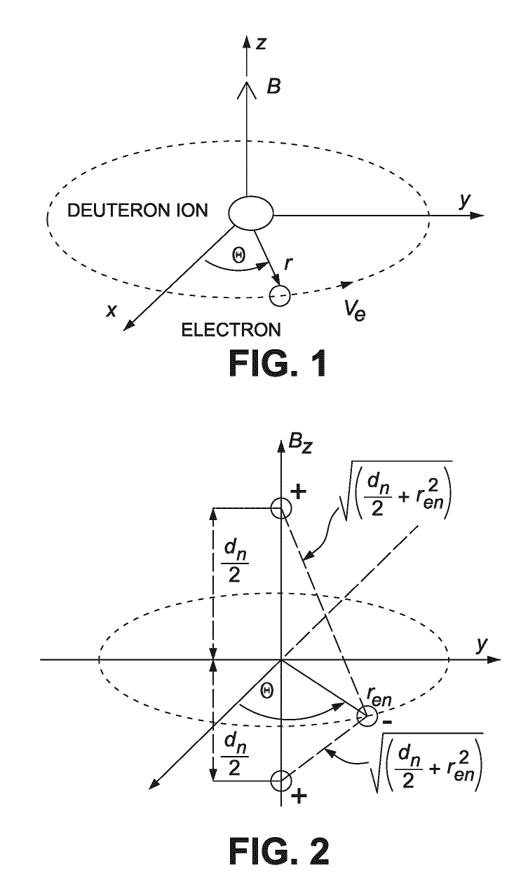

FIG. 1 is a drawing of an electron rotating about a deuteron ion. In FIG. 1, x, y, z are the rectilinear spatial coordinates; r is the radius from deuteron ion to the electron; e is the electronic charge of an electron and an ion; M is the mass of the nucleus (deuteron ion); m* is the mass of an electron; vₑ is the velocity of the electron orbiting the nucleus; B is the constant magnetic field density; and θ is the angle from the x-axis to the radial distance r.

In FIG. 1, the centrifugal force on the electron equals the coulomb force of attraction plus the magnetic Lorentz force. This can be represented mathematically as in the equation of motion shown in Eq. 1, where ε₀ is the dielectric permittivity of free space:

$$\frac{{m}^{*} {v}_{e}^{2}}{r} = \frac{{e}^{2}}{4 {πɛ}_{0} {r}^{2}} + {ev}_{e} B \qquad ( Eq . 1 )$$

To determine angular momentum, the electrons in atoms in the bound state are assumed to not radiate when in the presence of a magnetic field. This assumption is consistent with the observation that atoms in the stable state do not radiate when in the presence of a magnetic field. Consistent with Bohr's assumption, the angular momentum of the electron, P_{θ}, is constant. Applying Canuto and Kelly [1], P_{θ} can be expressed as in Eq. (2):

$${P}_{Θ} = {m}^{*} {r}_{en} {v}_{en} - \frac{1}{2} {eBr}_{en}^{2} = ( n + 1 ) \frac{h}{2 π} , n = 1 , 0 , 2 , … \qquad ( Eq . 2 )$$

In Eq. (2) rₑₙ is the radius of the orbit of the electron in the nth excited state, Vₑₙ is the velocity of the electron in the nth excited state, and h is Planck's constant.

The total energy of the electron in the n^{th} state, Wₙ, is Wₙ=Kinetic Energy of the n^{th} state+Potential Energy of the n^{th} state as in Eq. (3):

$${W}_{n} = \frac{1}{2} {m}^{*} {v}_{en}^{2} - \frac{{e}^{2}}{4 {πɛ}_{0} {r}_{en}} \qquad ( Eq . 3 )$$

A radius of the electron from the nucleus, rₙ, may be defined as in Eq. (4):

$${r}_{n} = \frac{{{ɛ}_{0} ( n + 1 )}^{2} {h}^{2}}{π {e}^{2} {m}^{*}} \qquad ( Eq . 4 )$$

For an electron in the ground state, n=0, ε₀=8.854×10⁻¹² farad/m; h=6.625×10⁻³⁴ joule-sec; e=1.602×10⁻¹⁹ coulombs; and m*=9.108×10⁻³¹ kilograms. The Bohr radius, r₀, is as shown in Eq. (5):

r₀=5.292×10⁻¹¹ (Eq. 5)

The ground state potential W_{OH} may be expressed as in Eq. (6):

$${W}_{OH} = - \frac{{e}^{2}}{8 {πɛ}_{0} {r}_{0}} \qquad ( Eq . 6 )$$

The radius R may be expressed as in Eq. (7):

$$R = \sqrt{\frac{h}{π eB}} \qquad ( Eq . 7 )$$

By solving from Eqs. (1), (2) and (3), the relationships for the discrete radii and energies result as shown in Eqs. (8) and (9) respectively:

$$\begin{matrix}\frac{{r}_{en}}{{r}_{0}} + {( \frac{{r}_{en}}{R} )}^{4} = {( n + 1 )}^{2} & ( Eq . 8 ) \\ {W}_{n} = \frac{eB}{{m}^{*}} ( n + 1 ) \frac{h}{4 π} + \frac{1}{4} \frac{{e}^{2} {B}^{2} {r}_{en}^{2}}{{m}^{*}} - \frac{{e}^{2}}{8 {πɛ}_{0} {r}_{en}} & ( Eq . 9 )\end{matrix}$$

In Aringazin [2], quantum mechanical modelling shows that the z size of the atom, L_{Z}, is expressed as in Eq. (10) (equation 3.36 using the numbering of the Aringanzin paper):

$${L}_{z} ≅ \frac{1}{ln ( \frac{B}{{B}_{0}^{′}} )} {r}_{0} \qquad ( Eq . 10 )$$

Taking 8′₀=2.4×10⁵ T as in Aringazin [2], Eq. 10 applies over a magnetic field strength range of

$${( 10 )}^{2} < \frac{B}{{B}_{0}^{′}} < {( 10 )}^{6} .$$

That is, the range of field strength values over which the model in Aringazin [2] applies is in the range of between 10⁷ T and 10¹¹ T. In that range, the amended Bohr model of H⁺ has greater than 70% overlap with the quantum mechanical model of a hydrogen atom in Aringazin [2]. At a magnetic field strength value of about 10⁶ T, an even greater agreement is shown between the amended Bohr model of a hydrogen atom and the quantum mechanical model of a hydrogen atom in Aringazin [2]. As the magnetic field strength is becomes lower (relative to the range of between 10⁷ T and 10¹¹ T), the agreement between the amended Bohr model of a hydrogen atom and the quantum mechanical model of a hydrogen atom increases.

Put otherwise, the transverse size, L_{⊥}, of the atom is given by its equation (3.37) in Aringazin [2]:

$$L ⊥ ≅ \frac{1}{\sqrt{B \text{/} {B}_{0}}} {r}_{0}$$

The value of L_{⊥} in Aringazin [2] and the value of R in Eq. (7) have the same B dependence with L_{⊥} being more than seventy percent of R. As can be seen from Eq. (8), rₑ₀ is even closer to L_{⊥}. For B/B′<10², the agreement between the amended Bohr theory model and the quantum model is even closer.

Magnetocompression

As above, magnetic compression of a fuel prior to laser irradiation may facilitate inertial confinement fusion by laser excitation. Details of magnetocompression of the amended Bohr model of H₂⁺ at three field strengths are provided below. The field strengths are 10² T, 2×10⁶ T, and 10¹⁵ T.

A magnetic field with a strength of B=10² T can be realized with current technology. From Eq. (7), at this field strength for n=0, R=3.628×10⁻⁹ m>>r₀ and rₑ₀. Based on Eq. (8) with the assumption that that rₑ₀≅r₀, then

$$\frac{{r}_{e 0}}{{r}_{0}} ≅ 1 - {( \frac{{r}_{0}}{R} )}^{4} = 0.999999955$$

and Δr=rₑ₀−r₀≅−0.45×10⁻⁷ m.
Magnetocompression resulting in a change of separation between the nucleus and the electron in the range of 10⁻⁷ m may be in the measurable range of compression. The magnetic energy required to produce a 100 T field in a volume (V) of 5 mm³ is

$$E = \frac{{B}^{2}}{{μ}_{0}} V = 39.77 joules .$$

A magnetic field strength of B=2×10⁶ T is chosen to be similar to one of the fields used by Canuto and Kelly [1], and yet realistically generated with current or near-future magnetic field generation methods. The transverse magnetic compression at this field strength can be calculated from Eq. (8) where R=2.566×10⁻¹¹ m, providing a ground state radius of each atom of rₑ₀=2.240×10⁻¹¹ m, which in view of Eq. (5), gives the radial compression ratio, \tilde{R}, of

$$\tilde{R} = \frac{2.240}{5.292} = 0.420 .$$

With such shrinkage, an increase in the probability of nuclear fusion events is expected, and is within the range of validity of Eq. (10) from [2]. The energy required to produce a 2×10⁶ T field in a volume of 5 mm³ is

$$E = \frac{{B}^{2}}{{μ}_{0}} V = 16 \times {10}^{9} joules .$$

To compress the atomic radius of the ground state electron to be near the range of the nuclear force means that rₑ₁ may be set to 10⁻¹⁵ m. The radial compression ratio is

$$\tilde{R} = \frac{{10}^{- 15}}{5.292 \times {10}^{- 11}} = 1.89 \times {10}^{- 5} .$$

From Eqs. (7) and (8) for rₑ₀=10⁻¹⁵ m, the magnetic field strength B required to effect this degree of compression is defined as in Eq. 11:

$$B = \frac{h}{π {er}_{e 0}^{2}} = 1.316 \times {10}^{15} T \qquad ( Eq . 11 )$$

The range of 10¹⁵ T is beyond any currently known magnetic field strength, more than many thousand times the upper field strength of a magnetar [5].

If Eq. 10 is presumed to be valid for B=10¹⁵ T (i.e. outside the range provided above in Aringazin [2] and shown in Eq. 10), then L_{z}≅2.4×10⁻¹² m. That is, at a B value in the range of 10¹⁵ T, the electron orbit in the ground state is about 2400 times larger in the z direction than in the transverse plane. Hence, the atom is string-like in such a large magnetocompression. If deuterium atoms are compressed transversely to an electron radius of 10⁻¹⁵ m, then atoms may encounter one another sufficiently closely to fuse and so facilitate fusion. In this circumstance coulomb repulsion would not be a factor since fusion would take place inside of the coulombic repulsion radius through nuclear contact.

Alternatively, if rₑₒ is two orders of magnitude larger in the range of 10⁻¹³ m, the magnetic field strength required, as seen from Eq. 11, is about 10¹¹ T, which is near the upper field strength of magnetars. At such a radius the prediction in [6] is that fusion can occur by quantum tunneling through the electrostatic barrier in the absence of laser excitation.

Electron Binding Energy for the Ground State Electron of Hydrogen

The amended Bohr model of H₂⁺ also shows the effects of intense magnetocompression on the ground state binding energy of the electron associated with a hydrogen atom. Magnetocompression increases the ground state binding energy of electrons and correspondingly inhibits ionization. An estimated expression for the binding energy, W_{B}, of the electron in ground state under magnetocompression can be found from Eqs. (6) and (9):

$$\frac{{W}_{B}}{{W}_{0 H}} = \frac{{r}_{0}}{{r}_{e 0}} \qquad ( Eq . 12 )$$

Applying Eq. (12) to the amended Bohr model of H₂⁺, the ratio of the increased electron binding energy, W_{B}, over W_{OH} is given in Table 1 for different values of B.

TABLE 1
W_{B}/W_{0H} for Different Values of B

| B (T) | rₑ₀(10)¹¹(m) | R (10)¹¹(m) | W_{B}/W_{0H} |
|---|---|---|---|
| 2 × 10⁶ | 2.237 | 2.566 | 2.37 |
| 1 × 10⁶ | 2.958 | 3.630 | 1.79 |
| 4.7 × 10⁵ | 3.835 | 5.292 | 1.38 |
| 1 × 10⁵ | 5.090 | 11.470 | 1.04 |
| 1 × 10⁴ | 5.290 | 36.300 | 1.0004 |

Applying Eq. (12) to the values shown in Table 1, magnetocompression of the hydrogen atoms in H₂⁺ increases the binding energy of the ground state electron. The magnitude of the increase in binding energy increases with increased magnetic field strength. By increasing the binding energy, the magnetocompression strengthens the interaction between the ground state electron and the nucleus. The increased binding energy of electrons would provide a benefit if applied prior to inertial confinement fusion in that an increase in binding energy of electrons in the sample delays ionization prior to plasma formation. The delay in ionization allows the laser to be exposed to more of the sample, meaning more compression occurs before an electron field forms and reflects the laser power. In some applications of inertial confinement fusion and MagLIF, over 99% of the energy provided by the laser is absorbed by an electron field.

From a quantum analysis it is shown that for fields greater than 4.7×10⁵ T, the characteristic atomic scales of length and binding energy are modified. Since the electron energy is distributed along the magnetic field axis as well as perpendicular, the quantum mechanical model may show a reduction in the binding energy from that given by the amended Bohr model applied herein. The binding energy ratio given in Table 1 below for B=2×10⁶ T is 2.37, which is more than most of the values given by Canuto and Kelly [1], in their Tables IV, V, VI. This is expected since a quantum mechanical model would generally be expected to show lower binding energy than an amended Bohr theory model. However, a binding energy ration of 3.14 is provided in the Even, n=0, s=0 column of Table IV, which is greater than the amended Bohr model value and a departure from the trend of lower binding energies in quantum mechanical models.

Magnetocompression of Bonding Between Atoms

In addition to compressing the atoms themselves, the magnetic field compresses the bonding distance between the atoms, which may facilitate inertial confinement laser fusion. A singly ionized H₂⁺ molecule was modelled using the amended Bohr model and studied under the influence of a constant magnetic field. The singly ionized H₂⁺ molecule was chosen as a simple extension of the work in [1] and [2], being a relatively simple three-body model. In addition, most fusion fuel would include isotopes of H₂, commonly either deuterium or deuterium and tritium, giving the amended Bohr model of H₂⁺ additional practical relevance. The reduction of the radius of the orbiting electron and the reduction in the distance between the two protons was examined.

The geometry of H₂⁺ is shown in FIG. 2. The below analysis provides values for rₑₙ and dₙ in the absence presence and absence of a magnetic field. The below analysis is based on the assumption that the electron is in a plane perpendicular to B_{z} and at an equal distance from each proton. It can be shown that if the angle from the origin to the plane is β, that sin β=0, and that β=1π, I=0, 1, 2, . . . .

B_{z}=0

For B_{z}=0, the centrifugal force on the electron equals the coulomb force of attraction in the plane of the electron's orbit due to the two protons. Consequently, for the n^{th} state, Eq. (13) is as follows:

$$\frac{{m}^{*} {v}_{en}^{2}}{{r}_{en}} - \frac{2 {e}^{2} sin ϕ}{4 {πɛ}_{0} [ {( \frac{{d}_{n}}{2} )}^{2} + {r}_{en}^{2} ]} = \frac{{e}^{2}}{2 {πɛ}_{0} [ {( \frac{{d}_{n}}{2} )}^{2} + {r}_{en}^{2} ]} ( \frac{{r}_{en}}{\sqrt{{( \frac{{d}_{n}}{2} )}^{2} + {r}_{en}^{2}}} ) = \frac{{e}^{2}}{2 {πɛ}_{0}} ( \frac{{r}_{en}}{{[ {( \frac{{d}_{n}}{2} )}^{2} + {r}_{en}^{2} ]}^{\frac{3}{2}}} ) \qquad ( Eq . 13 )$$

From Eq. (2),

$${v}_{en} = \frac{( n + 1 ) h}{2 π {m}^{*} {r}_{en}} ,$$

which, when substituted into Eq. (13), provides

$$\frac{{m}^{*}}{{r}_{en}} {( \frac{( n + 1 ) h}{2 π {m}^{*} {r}_{en}} )}^{2} = \frac{{e}^{2} {r}_{en}}{2 {{πɛ}_{0} [ {( \begin{matrix}{d}_{n} \\ 2\end{matrix} )}^{2} + {r}_{en}^{2} ]}^{\frac{3}{2}}}$$

### Therefore,

$${( \frac{{d}_{n}}{2} )}^{2} + {r}_{en}^{2} = {2}^{\frac{2}{3}} {( \frac{{r}_{en}}{{r}_{n}} )}^{\frac{2}{3}} {r}_{en}^{2} ,$$

or:

$$( \frac{{d}_{n}}{2} ) = ( \sqrt{1.5874 {( \frac{{r}_{en}}{{r}_{n}} )}^{\frac{2}{3}} - 1} ) {r}_{en} \qquad ( Eq . 14 )$$

The force on a proton is

$$0 = - \frac{{e}^{2}}{4 {πɛ}_{0} {d}_{n}^{2}} + \frac{{e}^{2}}{4 {πɛ}_{0}} ( \frac{cos ϕ}{[ {( \frac{{d}_{n}}{2} )}^{2} + {r}_{en}^{2} ]} )$$

also expressed as

$$0 = - \frac{{e}^{2}}{4 {πɛ}_{0} {d}_{n}^{2}} + \frac{{e}^{2}}{4 {πɛ}_{0}} ( \frac{1}{[ {( \frac{{d}_{n}}{2} )}^{2} + {r}_{en}^{2} ]} ) - \frac{\begin{matrix}{d}_{n} \\ 2\end{matrix}}{\sqrt{{( \begin{matrix}{d}_{n} \\ 2\end{matrix} )}^{2} + {r}_{en}^{2}}} , or {r}_{en}^{2} = [ {( \frac{1}{2} )}^{\frac{2}{3}} - \frac{1}{4} ] {d}_{n}^{2} .$$

Therefore:

rₑₙ=0.6164dₙ (Eq. 15)

Combining Eqs. (14) and (15) provides:

$$1 = ( \sqrt{1.5874 {( \frac{{r}_{en}}{2} )}^{\frac{2}{3}} - 1} ) ( 2 ) ( 0.6164 ) .$$

Therefore:

$$\begin{matrix}( \frac{{r}_{en}}{{r}_{n}} ) = 1.0674 \\ ( \frac{{d}_{n}}{{r}_{n}} ) = 1.7317\end{matrix} \} \qquad ( Eq . 16 )$$

For n=0, the ground state,

$$\begin{matrix}{r}_{e 0} = {r}_{e 00} = 0.5649 \times {10}^{- 10} m \\ {d}_{0} = {d}_{00} = 0.9164 \times {10}^{- 10} m \end{matrix} \} \qquad ( Eq . 17 )$$

B_{z}≠0

For B_{z}≠0 the Lorentz force is added to the centrifugal force on the electron. Consequently,

$$\frac{{m}^{*} {v}_{en}^{2}}{{r}_{en}} = \frac{{e}^{2}}{2 {πɛ}_{0}} ( \frac{{r}_{en}}{{[ {( \frac{{d}_{n}}{2} )}^{2} + {r}_{en}^{2} ]}^{\frac{3}{2}}} ) + {ev}_{en} {B}_{z}$$

or from Eq. (2),

$${v}_{en} = \frac{( n + 1 ) h}{2 π {n}^{*} {r}_{en}} + \frac{1}{2} \frac{{eB}_{z} {r}_{en}}{{m}^{*}} ,$$

then from Eq. (1),

$$\frac{{m}^{*}}{{r}_{en}} {( \frac{( n + 1 ) h}{2 π {n}^{*} {r}_{en}} + \frac{1}{2} \frac{{eB}_{z} {r}_{en}}{{m}^{*}} )}^{2} - \frac{{e}^{2} {r}_{en}}{2 {{πɛ}_{0} [ {( \frac{{d}_{n}}{2} )}^{2} + {r}_{en}^{2} ]}^{\frac{3}{2}}} + e ( \frac{( n + 1 ) h}{2 π {n}^{*} {r}_{en}} + \frac{1}{2} \frac{{eB}_{z} {r}_{en}}{{m}^{*}} ) {B}_{z} ,$$

which gives:

$$\frac{1}{2} {r}_{n} = \frac{{r}_{en}^{4}}{{[ {( \frac{{d}_{n}}{2} )}^{2} + {r}_{en}^{2} ]}^{\frac{3}{2}}} + \frac{1}{2} \frac{{r}_{0} {r}_{en}^{4}}{{R}^{4}} . \qquad ( Eq . 18 )$$

Since the Lorentz force does not act on the proton, Eq. (15) holds when the magnetic field is present. Consequently, substituting Eq. (15) into Eq. (18) gives:

$$1 = 0.9368 ( \frac{{r}_{en}}{{r}_{n}} ) + \frac{{r}_{0}}{{r}_{n}} {( \frac{{r}_{en}}{R} )}^{4} \qquad ( Eq . 19 )$$

From Eq. (19) for

$${B}_{z} = 0 , ( \frac{{r}_{en}}{{r}_{0 n}} ) = 1.0675 ,$$

and for B_{z}→∞, rₑₙ→0.
Since B_{z} exerts no force on the proton, Eq. (15) holds whether or not a B_{z} exists. For the ground state with n=0, set d₀=d₀₁ and rₑ₀=rₑ₀₁. Therefore, from Eqs. (19) and (15):

$$\begin{matrix}1 = 0.9368 ( \frac{{r}_{e 01}}{{r}_{0}} ) + {( \frac{{r}_{e 01}}{R} )}^{4} \\ {d}_{01} = 1.6223 {r}_{e 01}\end{matrix} \} \qquad ( Eq . 20 )$$

The second subscript “1” in rₑ₀₁ is for B_{z}≠0. For B_{z}=2×10⁶ T, R=2.566×10⁻¹¹ m and so from Eq. (19), rₑ₀₁=2.259×10⁻¹¹ m, and

d₀₁=3.665×10⁻¹¹ m (Eq. 21)

The comparative volume (V_{C}) is V_{C}=(πrₑ₀₁)²d₀₁. The V_{C} will allow a comparison to be made to indicate the shrinkage of the molecular volume due to the presence of a magnetic field. In turn, the resulting increase in density can be compared to the density when no magnetic field is present. For a constant mass, M, the molecular density is defined as

$${ς}_{C} = \frac{M}{{V}_{C}} .$$

With the electron in the ground state, for B_{z}=0, one sets V_{C}=V_{C0} and for B_{z}≠0 sets V_{C}=V_{C1}. Consequently, the corresponding ratio of molecular densities ( [symbol] ), which is an indicator of molecular shrinkage, is

$$= \frac{{ς}_{C 1}}{{ς}_{C 0}} = \frac{{V}_{C 0}}{{V}_{C 1}} = \frac{{d}_{00}}{{d}_{01}} {( \frac{{r}_{e 00}}{{r}_{e 01}} )}^{2} .$$

Based on Eqs. (17) and (20), when the magnetic field is 2×10⁶ T, a molecular shrinkage having a factor of almost 16 is achieved. As can be seen from Table 2, the magnitude of the shrinkage increases with an increase in magnetic field. Such shrinkages would be of assistance in an inertial confinement laser fusion process.

TABLE 2 [symbol]
and Molecular Density for Different values of Bz

| B_{z} (T) | R (10)⁻¹¹ (m) | d_{00/}d₀₁ | rₑ₀₀/rₑ₀₁ | [symbol] |
|---|---|---|---|---|
| 2 × 10⁶ | 2.566 | 2.500 | 2.500 | 15.63 |
| 1 × 10⁶ | 3.630 | 1.878 | 1.878 | 6.623 |
| 4.7 × 10⁵ | 5.292 | 1.434 | 1.439 | 2.949 |
| 1 × 10⁵ | 11.47 | 1.046 | 1.046 | 1.144 |
| 1 × 10⁴ | 36.30 | 1.000 | 1.000 | 1.000 |

Based on modeled data shown in Table 2, compressing a hydrogen isotope fuel source with a magnetic field in the range of at least 10⁵ T, with detailed information available for all the values shown in Tables 1 and 2, is expected to facilitate fusion when applied prior to excitation by a laser, similarly to applications such as inertial confinement fusion or magnetic confinement fusion. Compressing the molecules before excitation with the laser results in a corresponding reduction in the compression factor that the laser must provide. At a field strength of 2×10⁶ T, the compression induced by the magnetic field would facilitate fusion by reducing the level of compression which the laser must provide from a factor of about 6,000 to a factor of about 200.

Solenoid

The methods described herein are facilitated by concentrating energy into a sufficiently small volume to provide a magnetic field of at least 10⁵ T with currently available energy sources. A fuel container is provided using a solenoid design that concentrates the magnetic field to a smaller volume, amplifying the magnetic field within the solenoid, where the fuel is located.

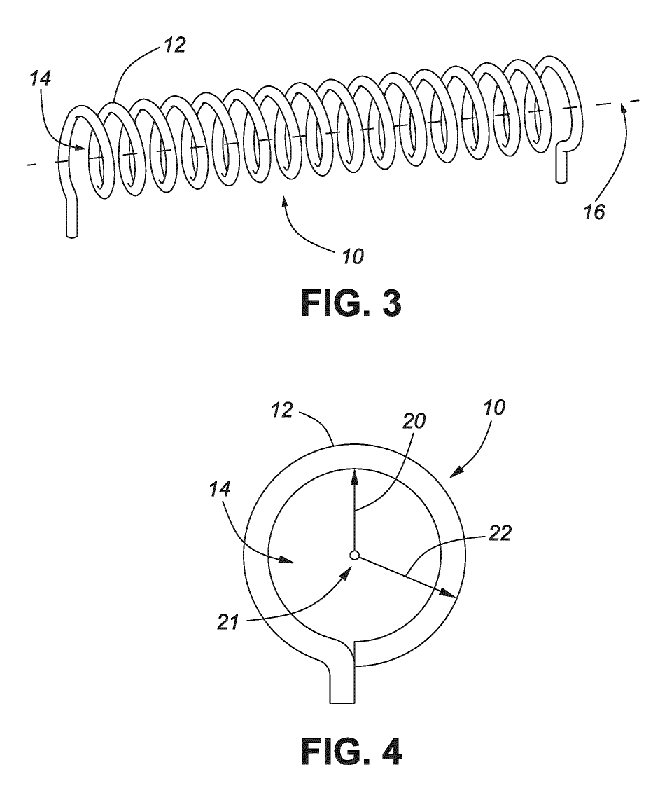

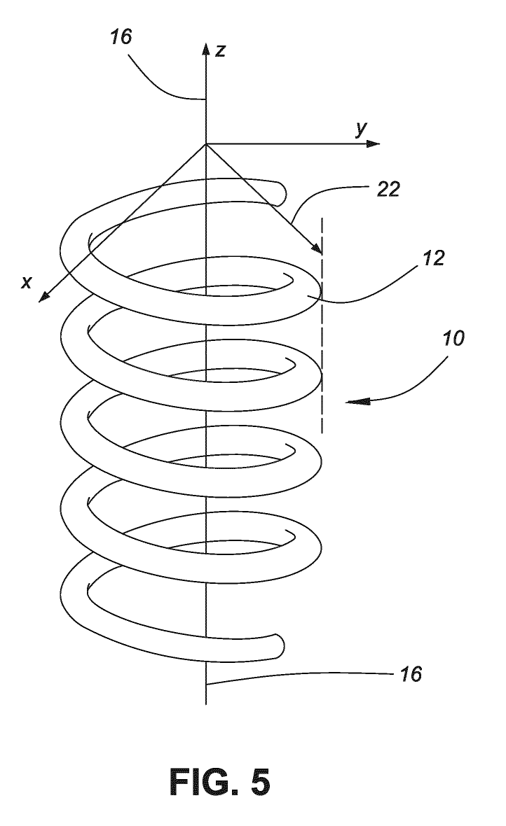

FIGS. 3 to 5 show a solenoid 10 including a conduction member 12 coiled in a helical pattern to define a cavity 14 within the solenoid 10. The cavity 14 extends along a longitudinal axis 16. FIG. 4 is shown with a view extending along the longitudinal axis 16. FIG. 5 shows the solenoid 10 with an x axis, a y axis, and a z axis in an x, y, z coordinate system. The z axis is coextensive with the longitudinal axis 16.

An inside radius 20 extends from a midpoint 21 of the solenoid 10 located along the longitudinal axis 16 to an inside surface of the conduction member 12. An outside radius 22 extends from the midpoint 21 to an outside surface of the conduction member 12. Radii are generally referred to as “r” in the equations below. The context of the equations makes it clear where the inside radius 20 or the outside radius 22 are referred to.

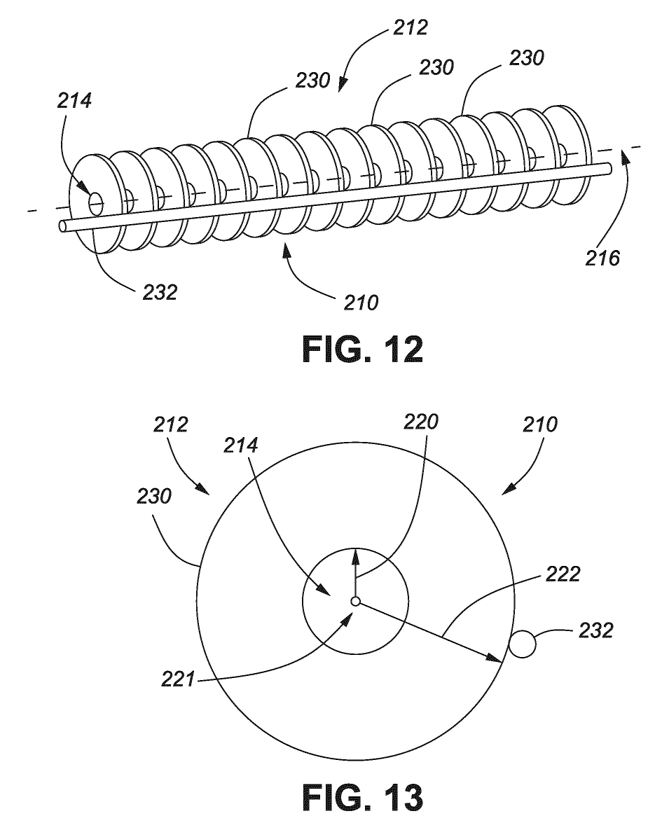

The difference between the value of the outside radius 22 and the value of the inside radius 20 is equal to the thickness of the conduction member 12 along a dimension extending radially with respect to the longitudinal axis 16. While the conduction member 12 is schematically shown as a coil with essentially uniform radial thickness, other conduction members that have a much greater thickness along the dimension extending radially with respect to the longitudinal axis 16 than along the longitudinal axis (e.g. see the solenoid 210 of FIGS. 12 and 13). The thickness along the dimension extending radially with respect to the longitudinal axis 16 of the conduction member 12 is referred to as A in the below equations. The value of the inside radius 20 is equal to the inside diameter divided by two (d/2). The value of the outside radius 22 is equal to the inside diameter divided by two plus the thickness A of the conduction member 12 (d/2+λ).

The conduction member 12 may include a composite material, which provides a highly conductive material. The composite material may include a conductor material such as copper, gold, or any suitable conductive metallic or non-metallic material. The composite material may also include a semiconductor material that has less conductivity alone than the conductor material such as carbon nanotubes, cuprate-perovskite ceramic.

The composite material may include carbon and copper. The composite material may include carbon nanotubes bonded with copper. The carbon nanotubes bonded with copper may be prepared by seeding a carbon nanotube forest with copper seed particles. The carbon nanotube forest may be a horizontally aligned carbon nanotube forest. The horizontally aligned carbon nanotube forest may be prepared from a vertically aligned carbon nanotube forest.

As shown in Subramaniam [9], carbon nanotubes bonded with carbon may be prepared by shearing a vertically aligned carbon nanotube forest to provide a horizontally aligned carbon nanotube forest. The horizontally aligned carbon nanotube forest may be exposed to copper seed particles that are electroplated onto the horizontally aligned carbon nanotube forest, resulting in a carbon nanotube-copper composite material.

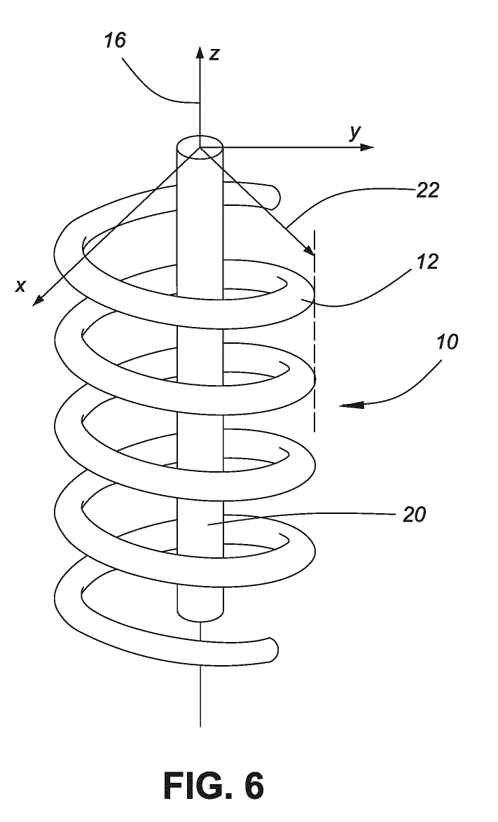

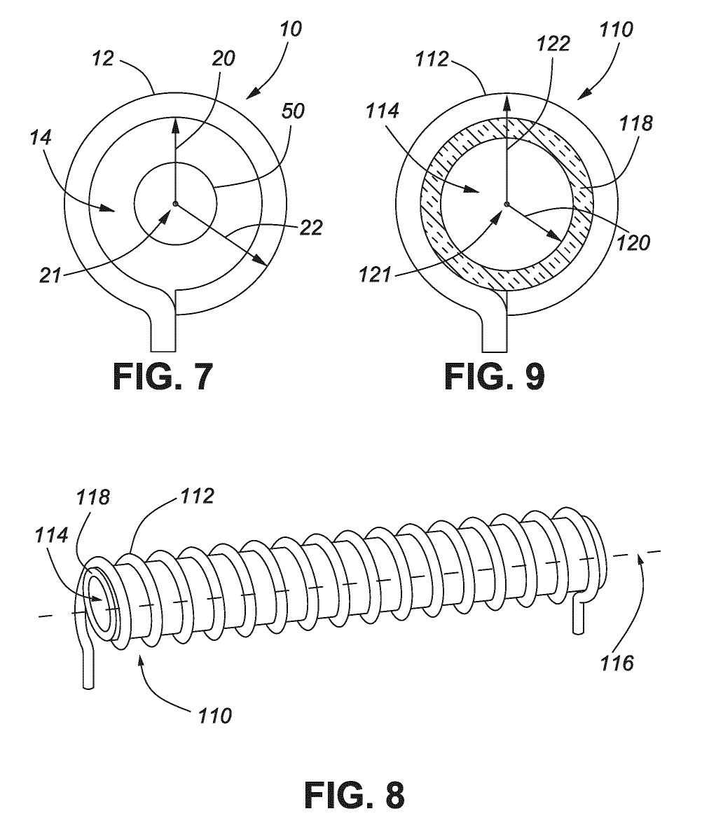

FIGS. 6 and 7 show the solenoid 10 including a target fuel material 50 in the cavity 14 for being exposed to a magnetic field for facilitating fusion. Alternatively, other material or a different target could be included in the solenoid 10 where a particular application requires an intense magnetic field to be applied to the material, or the field could be migrated longitudinally down the solenoid 10 towards an actuator, a sensor, an engine, or other appliance provided for an enduse of the magnetic field.

FIGS. 8 and 9 show a solenoid 110. The solenoid includes the conduction member 112 coiled in a helical pattern to define the cavity 114 within the solenoid 110. The cavity 114 extends along a longitudinal axis 116. FIG. 9 is shown with a view extending along the longitudinal axis 116. The solenoid 110 includes a body 118 manufactured from a non-conductive material for providing insulation between the cavity 114 and the conduction member 112.

The inside radius 120 (r in the equations below) extends from a midpoint 121 of the solenoid 110 located along the longitudinal axis 116 to the inside surface of the conduction member 112. The outside radius 122 extends from the midpoint 121 to the outside surface of the conduction member 112. The inside radius 120 and the outside radius 122 are defined with respect to the conduction member 112 and the thickness of the body 118 is not included in defining the thickness of the conduction member 112 or the corresponding value of λ.

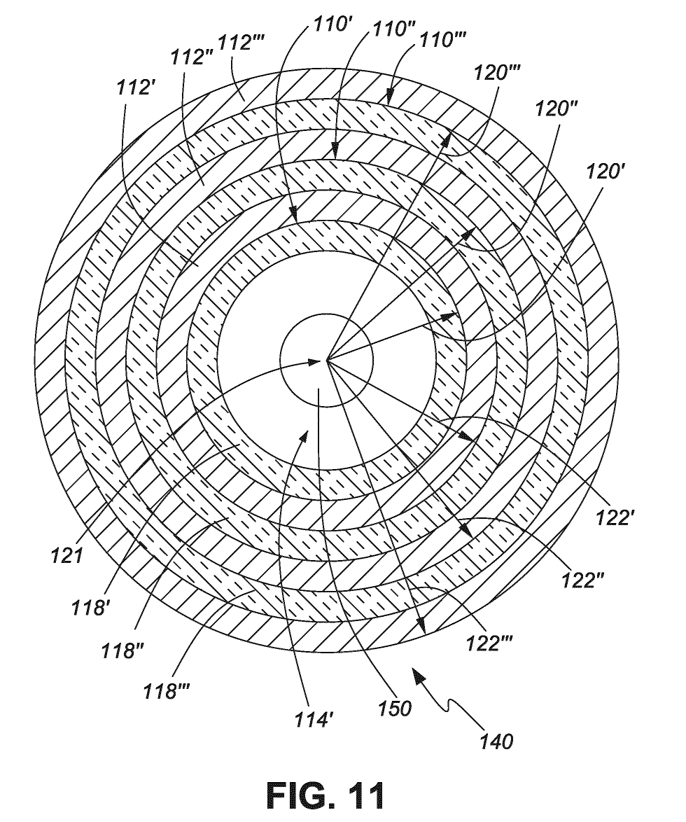

The difference between the value of the outside radius 122 and the inside radius 120 is equal to the thickness of the conduction member 112. As with the corresponding value in the solenoid 10, the thickness of the conduction member 112 is referred to as λ in the below equations. The value of the inside radius 120 may be equal to the inside diameter divided by two (d/2). The value of the outside radius 122 may be equal to the inside diameter divided by two plus the thickness of the conduction member 112 (d/2+λ). The thickness of the insulative body 118 may be equal to an integer value of λ, which may provide advantages when using concentrically arranged solenoids as described below with reference to FIG. 11.

Magnetic Field in Solenoid

The solenoidal structure may be altered in large magnetic fields. Canuto and Kelly [1] shows that for fields in excess of 4.7×(10)⁵ T, characteristic atomic scales of length and binding energy change in a hydrogen atom. Quantum mechanics shows that at higher magnetic field strengths, the orbit of a hydrogen atom's electron has some elongation in the direction of a strong magnetic field as shown by Aringazin [2]. In the amended Bohr model of Canuto and Kelly [1] defined above, the hydrogen ion molecule is compressed as the magnetic field increase and the molecule maintains its general form and for fields above about 4.7×(10)⁵ T, elongation is expected. These examples assume a constant magnetic field. By using the angular momentum expression given in the amended Bohr model, the orbital period, τ, of the ground state electron for hydrogen and its isotopes is:

$$τ = \frac{2 π {r}_{eo}}{{v}_{eo}} = \frac{2 π {m}^{*}}{\frac{h}{2 π {r}_{oo}^{2}} + \frac{1}{2} eB}$$

In the above equation for τ, vₑₒ is electron velocity, rₑₒ is electron orbital radius, and m* is mass of the electron. For B=0, τ=1.52×10⁻¹⁶ s. For the a magnetic field of 2×10⁶ T, τ=1.54×10⁻¹⁷ s. For any electromagnetic signal with a period much greater than 10⁻¹⁶ s, the magnetic field seen by the electron would be approximated as a constant. In the examples considered in this text the smallest period considered is 10⁻¹¹ S.

The impulse on the orbiting electron in the ground state is

Ī=∫ₜ_{₁}^{t}^{²}Fdt=∫ₜ_{₁}^{t}^{²}evₑₒBdt

Eliminating vₑₒ using the angular momentum term in the amended Bohr model gives

$$\overline{I} = 2 {( \frac{h}{2 π} )}^{2} \frac{1}{{m}^{*} {r}_{eo} {R}^{2}} [ \frac{{r}_{oo}}{R} + 1 ] ( {t}_{2} - {t}_{1} )$$

where B is assumed constant and

$${R}^{2} = \frac{h}{π eB}$$

If B=0, then [symbol] =0. For B→∞ then R→0 and rₑₒ=R→0, then [symbol] →∞. In the direct current case with t₂−t₁→∞ then [symbol] →∞. In the large field case with B=2×10⁶ T, R=2.57×10⁻¹¹ m and rₑₒ=2.24×10⁻¹¹ m. As a result, [symbol] =2.31×10⁻⁶(t₂−t₁). For t₂−t₁=1 s, T=2.31×10⁻⁶ N·s.

For a pulse with a duration of 0.01 ns, t₂−t₁=10⁻¹¹ s, then [symbol] =2.31×10⁻¹⁷ N·s. Compared with a value of t₂−t₁=1 s, t₂−t₁=10⁻¹¹ s is an approximation to a t₂−t₁ value of zero. The resulting magnetic field density depends on the properties of the solenoid and the frequency of the current applied to the solenoid as shown below in Tables 3 to 5.

A summary of how molecular structures behave when immersed in strong magnetic fields is provided below. A solenoidal magnetic system applied to the solenoid 10 may be defined with respect to the magnetic field only, and not the electric field, if the current-carrying conductive material inside the conduction member 12 is assumed to provide a perfect conductor. As shown below, this assumption is appropriate in this case.

Where a material in the solenoid 10, such as the target fuel material 50, is exposed to the magnetic field along the solenoidal longitudinal axis 16, the electric field is not of consequence as will be shown because the electric field on the longitudinal axis 16 is zero.

In the below equations, the following values are applied: B is the magnetic field density vector (T); H is the magnetic field intensity vector A/m); E is the electric field intensity vector (V/m); D is the electric field density vector (V/m); j is the electric current surface density (A/m²); δ is the electric charge density (C/m³); p is the magnetic permittivity B=μH); E is the electric permittivity (D=εE); and w is the signal frequency (s⁻¹).

We assume that Bᵣ=B_{θ}=E_{z}=Eᵣ=jᵣ=j_{z}=δ=0. This leaves only r and t dependence remaining to be defined. The current j_{θ} flows around the solenoid 10 with an inside diameter of d=2r₀ and where r₀ is the inside radius 20. From Maxwell's equations in cylindrical coordinates:

$$\begin{matrix}\frac{1}{r} \frac{\partial }{\partial r} ( {rE}_{θ} ) = - \frac{\partial {B}_{z}}{\partial t} & ( Eq . 22 ) \\ - \frac{\partial {H}_{z}}{\partial r} = {j}_{θ} + \frac{\partial {D}_{θ}}{\partial t} & ( Eq . 23 )\end{matrix}$$

For 0≤r≤d/2 with j_{θ}=0, Eq. (23) becomes:

$$- \frac{\partial {H}_{z}}{\partial r} = \frac{\partial {D}_{θ}}{\partial t}$$

and from Eq. (22):

$$\frac{\partial }{\partial r} [ \frac{1}{r} \frac{\partial }{\partial r} ( {rE}_{θ} ) ] = μɛ \frac{{\partial }^{2} {E}_{θ}}{\partial {t}^{2}} \qquad ( Eq . 24 )$$

Assuming a time dependence e^{-lωt}, then from Eq. (24):

$$\frac{\partial }{\partial r} [ \frac{1}{r} \frac{\partial }{\partial r} ( {rE}_{θ} ) ] = - {ω}^{2} μɛ {E}_{θ}$$

With E_{θ}=A_{θ}e^{-lωt}, the solution for A_{θ} is:

A_{θ}=C₁J₁(ω\sqrt{με}r)+C₂N₁(ω\sqrt{με}r)

Since E_{θ} must be finite for r=0 and N₁(0)→0, then C₂=0₁ and A_{θ} may be redefined as:

A₀=C₁J₁(ω\sqrt{με}r) (Eq. 25)

At r=d/2, assuming a perfect conditioning boundary:

$${A}_{θ} ( \frac{d}{2} ) = {C}_{1} {J}_{1} ( \frac{ω \sqrt{μɛ} d}{2} ) = 0 \qquad ( Eq . 26 )$$

Eq. (26) may be rewritten as:

ωₗ\sqrt{με}d=2δₗ (Eq. 27)

In Eq. (27), δ₁ is the I^{th} root of:

$${J}_{1} ( \frac{ω \sqrt{μɛ} d}{2} )$$

and δ₁ and δ₁=3.832, 7.016, 10.173, 13.3 . . . .

Based on Eq. (22),

$${B}_{z} = ( \frac{1}{i ω r} ) [ r + \frac{\partial {E}_{θ}}{\partial r} + {E}_{θ} ]$$

### and E_{θ} is:

E_{θ}=C₁J₁(ω\sqrt{με}r)e^{-iωt} (Eq. 28)

Based on Eq. (28):

$$\begin{matrix}{B}_{z} = \frac{{C}_{1}}{l ω} [ \frac{{dJ}_{1}}{dr} + \frac{1}{r} {J}_{1} ] {e}^{- i ω t} \\ = \frac{{C}_{1}}{l} \sqrt{μɛ} [ \frac{{dJ}_{1} ( ω \sqrt{μɛ} r )}{ω \sqrt{μɛ} dr} + \frac{1}{ω \sqrt{μɛ} r} {J}_{1} ( ω \sqrt{μɛ} r ) ] {e}^{- i ω t} \\ = \sqrt{μɛ} \frac{{C}_{1}}{l} [ {J}_{0} ( ω \sqrt{μɛ} r ) ] {e}^{- i ω t}\end{matrix}$$

The above may be solved for B_{z} as.

$${B}_{z} = \sqrt{μɛ} \frac{{C}_{1}}{l ω} {J}_{0} ( ω \sqrt{μɛ} r ) {e}^{- i ω t} \qquad ( Eq . 29 )$$

From Eqs. (25) and (29), and evaluating B_{z} at r=0, then

$$\frac{{C}_{1}}{l} = \frac{{B}_{z} ( 0 )}{\sqrt{μɛ}} ,$$

where C₁ is an integration constant meaning that:

B_{z}(r,t)=B_{z}(0)J₀(ω\sqrt{με}r)e^{-iωt} (Eq. 30)

$${E}_{θ} ( r , t ) = \frac{{lB}_{z} ( 0 )}{\sqrt{μɛ}} {J}_{1} ( ω \sqrt{μɛ} r ) {e}^{- i ω t} \qquad ( Eq . 31 )$$

The perfect conductor assumption is based first on the Ohm's Law result where using the measured carbon-copper nanotube values by Subramanian, et. al [9] with j_{θ}=6.3×10¹² A/m² and the conductivity σ=4.7×10⁷ s/m results in an electric field of 1.3×10⁵ V/m. With that assumption, then from a least favorable case where B_{z}(0)=10T, then from Eq. (31), the maximum E_{θ}(1.8)=1.7×10⁹ V/m. This latter electric field is four orders of magnitude larger than the former. As a result, with comparison to the 1.7×10⁹ V/m figure, the electric field of 1.3×10⁵ V/m is a justifiable approximation of the assumption.

Magnetic Field Boundary Condition

At r=d/2 (the inside radius 20 of the conductions member 12), ignoring the displacement current of

$$\frac{\partial {D}_{θ}}{\partial t} ,$$

Eq. (23) provides:

$$- {\int }_{\frac{d}{2}}^{\frac{d}{2} + λ} \frac{\partial {B}_{z}}{\partial t} dr = μ {\int }_{\frac{d}{2}}^{\frac{d}{2} + λ} {j}_{θ} dr \qquad ( Eq . 32 )$$

In Eq. (32), A is the thickness of the conduction member 12 of the solenoid 10. The magnetic field at the outer surface of the doubting material, r=d/2+λ (the outside radius 22 of the conduction member 12), is taken as zero. Based on Eq. (32):

$${B}_{z} ( \frac{d}{2} ) = μ {\int }_{\frac{d}{2}}^{\frac{d}{2} + λ} {j}_{θ} dr \qquad ( Eq . 33 )$$

With j_{θ}=j_{θ0}e^{-iωt} and j_{θ0} set as a constant, j_{θ} will increase to some extent as B_{z} increases because of compression of A. This effect is expected to be minor and can be disregarded, leading to Eq. (33):

$${B}_{z} ( \frac{d}{2} ) = μ {j}_{θ} λ \qquad ( Eq . 34 )$$

By returning to Eqs. (29) and (34) at r=d/2:

$$\sqrt{μɛ} {J}_{0} ( ω \sqrt{μɛ} \frac{d}{2} ) \frac{{C}_{1}}{l} {e}^{- i ω t} = μ {j}_{θ} λ$$

C₁/i may be solved as follows:

$$\frac{{C}_{1}}{l} = \frac{μ λ {j}_{{θ}_{0}}}{\sqrt{μɛ} {J}_{0} ( ω \sqrt{μɛ} \frac{d}{2} )}$$

The above solution for C₁/i may be combined with Eq. (29) to provide a solution for B_{z} as follows:

$${B}_{z} = μ {j}_{θ 0} λ \frac{{J}_{0} ( ω \sqrt{μɛ} r )}{{J}_{0} ( ω \sqrt{μɛ} \frac{d}{2} )} {e}^{- i ω t} \qquad ( Eq . 35 )$$

For r=0 and solving for Eqs. 34 and 35, where B_{z}=B_{z}(0)e^{-iωt}, B_{z}(0) may be solved as:

$${B}_{z} ( 0 ) = \frac{μ λ {j}_{{θ}_{0}}}{{J}_{0} ( ω \sqrt{μɛ} \frac{d}{2} )}$$

Similarly, B_{z}(d/2) may be solved as:

$${B}_{z} ( \frac{d}{2} ) = {J}_{0} ( ω \sqrt{μɛ} \frac{d}{2} ) {B}_{z} ( 0 )$$

Based on the above, A may be solved as:

$$λ = \frac{{B}_{z} ( 0 ) {j}_{0} ( ω \sqrt{μɛ} \frac{d}{2} )}{μ {j}_{θ 0}} \qquad ( Eq . 36 )$$

Generally, metallic nanotubes are understood to carry an electric current density of (see e.g. Wikipedia as shown in reference [10]):

j_{θ0}=4×10¹³ A/m² (Eq. 37)

Subramanian, et. al [9] have measured carbon-copper nanotube composite conductors and observed an ampacity of 6×10¹² A/m². Applying the j_{θ0} value of 4×10¹³ A/m² from Eq. (37) to Eq. (36), Δ may be solved as follows to provide a selected magnetic field density:

$$λ = 1.989 {( 10 )}^{- 8} {J}_{0} ( ω \sqrt{μɛ} \frac{d}{2} ) {B}_{z} ( 0 ) \qquad ( Eq . 38 )$$

Applying Eq. (33) and recognizing that differential current may be defined as either of dl_{θ} e^{-ωt}=j_{θ}dzdr, or dl_{θ}=j_{θ}dzdr, then for

$${B}_{Z} ( \frac{d}{2} ) = {B}_{Z 0} ( \frac{d}{2} ) {e}^{- i ω t}$$

in a solenoid having a length of L:

$${B}_{z 0} ( \frac{d}{2} ) = μ {\int }_{\frac{d}{2}}^{\frac{d}{2} + λ} {j}_{θ 0} dr$$

$${I}_{θ} = {\int }_{0}^{L} {\int }_{\frac{d}{2}}^{\frac{d}{2} + λ} {j}_{θ 0} dr = L {\int }_{\frac{d}{2}}^{\frac{d}{2} + λ} {j}_{θ 0} dr$$

As a result:

$${B}_{z 0} ( \frac{d}{2} ) = μ \frac{{I}_{θ}}{L} = {J}_{0} ( ω \sqrt{μɛ} \frac{d}{2} ) {B}_{z 0} ( 0 ) \qquad ( Eq . 39 )$$

For N current loops existing in length L with each loop current represented by I_{θN}, then I_{θ}=NI_{θN}. It follows that

$${B}_{z 0} ( \frac{d}{2} ) = μ \frac{N}{L} {I}_{θ N} .$$

By defining Δ=L/N, B_{z0}(d/2) may be solved as

$${B}_{z 0} ( \frac{d}{2} ) = \frac{μ}{Δ} {I}_{θ N} ,$$

which may be redefined as

$${J}_{0} ( ω \sqrt{μɛ} \frac{d}{2} ) {B}_{z 0} ( 0 ) = \frac{μ}{Δ} {I}_{θ N} ,$$

allowing I_{θN} to be solved as either of:

$$\begin{matrix}{I}_{θ N} = Δ \frac{{J}_{0} ( ω \sqrt{μɛ} \begin{matrix}d \\ 2\end{matrix} ) {B}_{z 0} ( 0 )}{μ} & ( Eq . 40 ) \\ {I}_{θ N} = \frac{1}{N} {I}_{θ} = \frac{L}{N} {\int }_{\frac{d}{2}}^{\frac{d}{2} + λ} {j}_{θ 0} dr & ( Eq . 41 )\end{matrix}$$

Concentric Solenoids

Placing two or more solenoids in concentric orientation to one another may further increase B inside the innermost of the two or more solenoids. Using two or more solenoids allows a selected value of B to be achieved while mitigating the total current through either of the two solenoids individually.

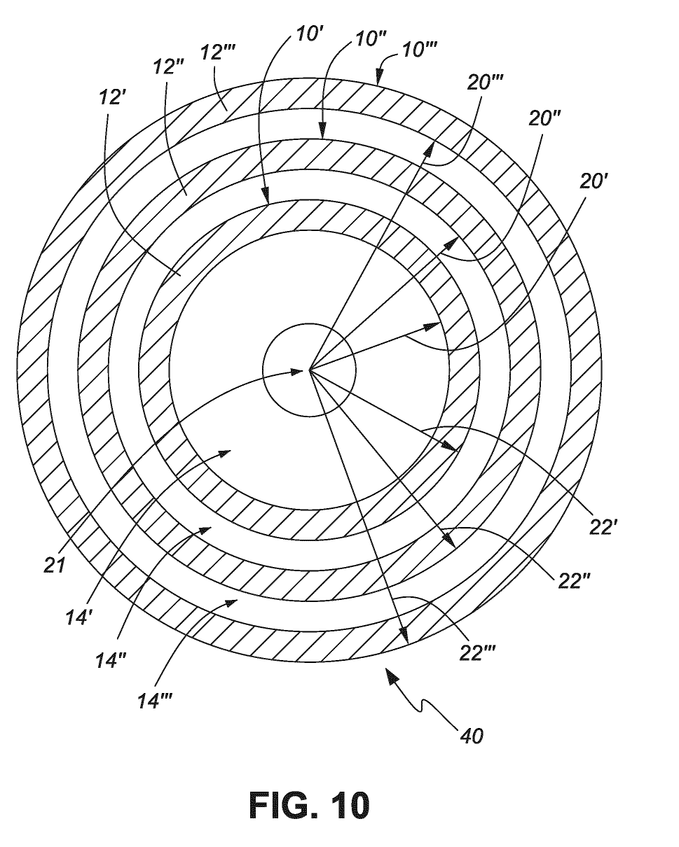

FIG. 10 shows a solenoid 10′ located concentrically inside a solenoid 10″, which is in turn located concentrically in a solenoid 10″. Further solenoids may be located concentrically around the solenoid 10″. The value of λ is constant across each of the solenoid 10′, the solenoid 10″, and the solenoid 10″. The inside radius 20′, the inside radius 20″, the inside radius 20′″, the outside radius 22′, the outside radius 22″, and the outside radius 22′″ are each calculated from the common midpoint 21. The cavity 14′ includes the fuel material 50 or other magnetic field target. The solenoid 10′ is separated from the solenoid 10″ by the cavity 14″. The solenoid 10″ is separated from the solenoid 10′″ by the cavity 14′″.

In the arrangement of the solenoid 10′, the solenoid 10″, and the solenoid 10′″, the inside radius 20′ is at a value of r=d/2 from the midpoint 21. The outside radius 22′ is at a value of r=d/2+λ, where B_{z} is expected to be zero. Boundary condition means that the electric field on a perfectly conducting surface is zero.

FIG. 11 shows a solenoid 110′ located concentrically inside a solenoid 110″, which is in turn located concentrically in a solenoid 110′″. Further solenoids may be located concentrically around the solenoid 110″. The value of λ is constant across each of the solenoid 110′, the solenoid 110″, and the solenoid 110′″. The inside radius 120′, the inside radius 120″, the inside radius 120″, the outside radius 122′, the outside radius 122″, and the outside radius 122′″ are each calculated from the common midpoint 121.

The body 118′, the body 118″, and the body 118′″ each have a thickness that is also equal to A, as with the conduction member 112′, the conduction member 112″, and the conduction member 112′″, facilitating a concentric arrangement of the solenoids 110′, 110″, and 110′″ in which the body 118″ occupies substantially the entire space between the conduction member 112′ and the conduction member 112″, and the body 118′″ occupies essentially the entire space between the conduction member 112″ and the conduction member 112′″. In this concentric arrangement, the successive conduction members 112′, 112″, and 112′″ are separated from one another by λ, the same value as the thickness of each conduction member 112′, 112″, and 112′″. The cavity 114′ includes the fuel material 150 or other magnetic field target.

Where multiple concentric solenoids are applied, λ from Eq. (41) may be divided into sections of λ/n. Where each section is excited independently by an independent realizable current, then:

$$\begin{matrix}{I}_{0 N} = & \frac{L}{N} [ {\int }_{\frac{d}{2}}^{\frac{d}{2} + \frac{1}{n} λ} {j}_{O 0} dr + {\int }_{\frac{d}{2} + \frac{1}{n} λ}^{\frac{d}{2} + \frac{2}{n} λ} {j}_{O 0} dr + ⋯ + \\ & {\int }_{\frac{d}{2} + \frac{m - 1}{n} λ}^{\frac{d}{2} + \frac{m}{n} λ} {j}_{θ 0} dr + ⋯ {\int }_{\frac{d}{2} + \frac{n - 1}{n} λ}^{\frac{d}{2} + \frac{m}{n} λ} {j}_{θ 0} dr ] \\ = & \frac{L}{N} {\sum }_{m = 1}^{n} {\int }_{\frac{d}{2} + \frac{m - 1}{n} λ}^{\frac{d}{2} + \frac{m}{n} λ} {j}_{θ 0} dr = {\sum }_{m = 1}^{n} {I}_{θ Nnm}\end{matrix}$$

For n greater than 1, the above equation approximates I_{θN} at values of λ far below d.

I_{θNnm} may be solved as:

$${I}_{θ Nnm} = \frac{L}{N} {\int }_{\frac{d}{2} + \frac{( m - 1 )}{n} λ}^{\frac{d}{2} + \frac{m}{n} λ} λ d {j}_{θ 0} dr \qquad ( Eq . 42 )$$

Here, I_{θNnm} represents the m^{th} current flowing in the n^{th} solenoid. Each solenoid has an electrical current independent of the other solenoids and the conduction member of each solenoid must be insulated from the conduction members of neighbouring solenoids. In FIG. 10, the conduction member 12′ is separated from the conduction member 12″ by the cavity 14″ and the conduction member 12″ is separated from the conduction member 12′″ by the cavity 14″. In FIG. 11, the conduction member 12′ is separated from the conduction member 12″ by the body 18″ and the conduction member 12″ is separated from the conduction member 12′″ by the body 18′″.

Energy Stored in a Solenoid

Based on Eqs. (25) and (29), C₁/i may be solved as:

$$\frac{{C}_{1}}{l} = \frac{{B}_{z 0} ( 0 )}{\sqrt{μɛ}}$$

Based on this solution for C₁/i:

$$\begin{matrix}{B}_{z} ( r , t ) = {B}_{z 0} ( 0 ) {J}_{0} ( ω \sqrt{μɛ} r ) {e}^{- i ω t} & ( Eq . 43 ) \\ {E}_{θ} ( r , t ) = \frac{i {B}_{z 0} ( 0 )}{\sqrt{μɛ}} {J}_{1} ( ω \sqrt{μɛ} r ) {e}^{- i ω t} & ( Eq . 44 )\end{matrix}$$

The average magnetic energy stored in a solenoid is:

$$\begin{matrix}{\hat{ɛ}}_{H} = \frac{1}{4} {\int }_{V} {B}_{z} {H}_{z} dV \\ = \frac{π {B}_{Z 0}^{2} ( 0 )}{2 μ} {\int }_{0}^{L} {\int }_{0}^{\frac{d}{2}} r {J}_{0}^{2} ( ω \sqrt{μɛ} r ) dr dz \\ = \frac{π {B}_{Z 0}^{2} ( 0 ) L}{2 μ} {\int }_{0}^{d \text{/} 2} r {J}_{0}^{2} ( ω \sqrt{μɛ} r ) dr\end{matrix} \qquad ( Eq . 45 )$$

Where dV=2πrdzdr, the corresponding electrical energy stored is:

$${\hat{ɛ}}_{E} = \frac{π {B}_{Z 0}^{2} ( 0 ) L}{2 μ} {\int }_{0}^{d \text{/} 2} r {J}_{1}^{2} ( ω \sqrt{μɛ} r ) dr \qquad ( Eq . 46 )$$

For

$$ω \sqrt{μɛ} \frac{d}{2} = {δ}_{l} ,$$

as described in Kreider et. al [11], the stored electrical energy may be solved as:

$${\hat{ɛ}}_{H} = {\hat{ɛ}}_{E} = \frac{π {B}_{Z 0}^{2} ( 0 ) L}{2 μ} ( \frac{1}{2} ) {( \frac{d}{2} )}^{2} {J}_{0}^{2} ( ω \sqrt{μɛ} \frac{d}{2} ) \qquad ( Eq . 47 )$$

Where w=0,

$${\hat{ɛ}}_{H} = \frac{π {B}_{Z}^{2} ( 0 ) L}{2 μ} ( \frac{1}{2} ) {( \frac{d}{2} )}^{2} and {\hat{ɛ}}_{E} = 0.$$

As above, when exposed to large magnetic fields and the associated energies involved, hydrogen atoms may be compressed but retain their overall form based on Canuto and Kelly [1] and Aringazin [2], and as shown in Table 2 above. As a result, with the atom's form largely maintained in Canuto and Kelly [1] and Aringazin [2], the focus is the shrinkage of the atom. Where the conduction members are assumed to be perfect conductors, the electric field approaches zero on the conduction members. For material such as a fusion target on axis, the electric field is not of consequence because on axis it is zero.

Example Solenoid at Direct Current, First and Fourth Eigenvalues

Table 3 below provides \hat{ε}_{H}, the solenoidal energy stored (\hat{ε}_{H}; J), thickness of the conduction member 12 (λ; mm), the current flowing in one (I_{θN}; A), and the number of nested solenoids required for I_{θNnm}≈100 A; along with the resultant current per solenoid in A) at selected values of B_{z}(0) from 10 T to 2×10⁶ T for direct current application of the electromagnetic field.

Table 4 below provides the same data fields as Table 3 at the same values of B_{z}(0) from 10 T to 2×10⁶ T for application of the first order eigenvalue of the electromagnetic field.

Table 5 below provides the same data fields as Table 3 at the same values of B_{z}(0) from 10 T to 2×10⁶ T application of the fourth order eigenvalue of the electromagnetic field.

In Tables 3 and 4 for B_{z}(0) at 4.7×10⁵ T, 1×10⁶ T and 2×10⁶ T, the values of I_{θNnm} provide an indication of the number of concentric solenoids required to reach the indicated magnetic field strength with the λ and other parameters shown. Similarly, in Table 5 for 1×10⁶ T and 2×10⁶ T the values of I_{θNnm} provide an indication of the number of concentric solenoids required to reach the indicated magnetic field strength with the λ and other parameters shown. In the case where λ is of the order of d, the electric field of the outer conduction members 12′″ affects the magnetic field of the inner conduction member 12″. Similarly, where the conduction member 12″ is considered an outer conduction member, the corresponding magnetic field of the inner conduction member 12′ is affected by the electric field of the outer conduction members 12″. The terms “inner” and “outer” as between the conduction members 12′, 12″, 12′″ are relative, as the conduction member 12″ is both an inner and an outer conduction member depending on the reference point.

For the direct current case in which w=0 and J₀(ω\sqrt{με}r)=1, Eq. (30) is approximately correct up to electromagnetic signal frequencies satisfying

$$ω \sqrt{μɛ} \frac{d}{2} << 3.83$$

where 3.83 is the first zero of

$${J}_{1} ( ω \sqrt{μɛ} \frac{d}{2} ) = 0.$$

In Table 3, values are given for \hat{ε}_{H}, I_{θN}, λ, and n with I_{θNnm}≈100 A. These values are provided with a solenoid similar to the solenoid 10 with a Δ=10⁻⁶ m (the azimuthal thickness of the conduction member 12, which is equal to UN), d=10⁻² m, and L=5×10⁻² m, resulting in an N value of 5.0×10⁷ turns. The values are provided and for B_{z}(0) values of between 10 T and 2×10⁶ T. As B_{z}(0) increases, the values of \hat{ε}_{H}, λ, I_{θN}, and n increase. If d and L are each reduced by a factor of 10, \hat{ε}_{H} is reduced by a factor of 1,000. From Eq. (39),

$${I}_{θ N} = \frac{A {B}_{z 0} ( 0 )}{μ} .$$

TABLE 3
\hat{ε}_{H}, I_{θN}, λ, and n with I_{θNnm} ≈ 100 A for Different Values of B_{z}(0)

| B_{z}(0) (T) | \hat{ε}_{H} (J) | λ (mm) | I_{θN} (A) | n |
|---|---|---|---|---|
| 10 | 39.1 × 10⁰ | 0.0002 | 0.00796 | 1 |
| 100 | 39.1 × 10² | 0.0020 | 0.0796 | 1 |
| 1,000 | 39.1 × 10⁴ | 0.0200 | 0.7960 | 1 |
| 10,000 | 39.1 × 10⁶ | 0.2000 | 7.9600 | 1 |
| 100,000 | 39.1 × 10⁸ | 2.0000 | 79.6000 | 1 |
| 470,000 | 86.4 × 10⁸ | 9.4000 | 374.0000 | I_{θNnm} = 93.5 A; 4 |
| 1,000,000 | 39.1 × 10¹⁰ | 20.0000 | 796.0000 | I_{θNnm} = 99.5 A; 8 |
| 2,000,000 | 15.64 × 10¹⁰ | 40.0000 | 1,592.0000 | I_{θNnm} = 99.5 A; 16 |

Based on the values in Table 3, for the first order eigenvalue

$$ω \sqrt{μɛ} \frac{d}{2} = 3.832 or f = \frac{3.832}{π \sqrt{μɛ} d} ,$$

where μ=μ₀, ε=ε₀ and d=10⁻² m, f=36.6 GHz. If ε=100_{ε0}, either f, d, or both can be reduced. By reducing d, it becomes d=10⁻³ m. Here, J₀ (3.832)=−0.402 and so:

$$\vert {I}_{θ N} \vert = \frac{0.402 Δ {B}_{z 0} ( 0 )}{μ} .$$

Table 4 shows the values of \hat{ε}_{H}, λ, I_{θN}, and the number of concentric solenoids required, to reach the same magnetic field density values as shown in Table 3, with the Bessel function at the first eigenvalue rather than at zero (direct current).

TABLE 4
\hat{ε}_{H}, I_{θN}, λ, and n with I_{θNnm} ≈ 100 A for Different Values of B_{z}(0)

| B_{z}(0) (T) | \hat{ε}_{H} (J) | λ (mm) | I_{θN} (A) | n |
|---|---|---|---|---|
| 10 | 15.7 × 10⁰ | 0.00008 | −0.0032 | 1 |
| 100 | 15.7 × 10² | 0.00080 | −0.0320 | 1 |
| 1,000 | 15.7 × 10⁴ | 0.00800 | −0.3200 | 1 |
| 10,000 | 15.7 × 10⁶ | 0.08000 | −3.2000 | 1 |
| 100,000 | 15.7 × 10⁸ | 0.80000 | −32.0000 | 1 |
| 470,000 | 346.8 × 10⁸ | 3.80000 | −150.0000 | I_{θNnm} = −75 A; 2 |
| 1,000,000 | 15.7 × 10¹⁰ | 8.00000 | −320.0000 | I_{θNnm} = −80 A; 4 |
| 2,000,000 | 62.8 × 10¹⁰ | 16.00000 | −640.0000 | I_{θNnm} = −91.4 A; 7 |

For the fourth order field eigenvalue mode

$$f = \frac{13.3}{π \sqrt{μɛ} d} ,$$

with μ=μ₀, ε=ε₀ and d=10⁻² m, f=127 GHz. If ε=100_{ϵ0}, either f, d, or both can be reduced. By reducing d, it becomes d=10⁻³ m. Here, J₀ (13.3)=0.218 and Eq. (40) provides

$${I}_{θ N} = \frac{0.218 Δ {B}_{z 0} ( 0 )}{μ}$$

Table 5 shows the values of \hat{ε}_{H}, λ, I_{θN}, and the number of concentric solenoids required, to reach the same magnetic field density values as shown in Table 3, with the Bessel function at the fourth eigenvalue rather than at zero (direct current).

TABLE 5
\hat{ε}_{H}, I_{θN}, λ, and n with I_{θNnm} ≈ 100 A for Different Values of B_{z}(0)

| B_{z}(0) (T) | \hat{ε}_{H} (J) | λ (mm) | I_{θN} (A) | n |
|---|---|---|---|---|
| 10 | 1.858 × 10⁰ | 0.0000434 | 0.00174 | 1 |
| 100 | 1.858 × 10² | 0.0004340 | 0.01740 | 1 |
| 1,000 | 1.858 × 10⁴ | 0.0043400 | 0.17400 | 1 |
| 10,000 | 1.858 × 10⁶ | 0.0434000 | 0.17400 | 1 |
| 100,000 | 1.858 × 10⁸ | 0.4340000 | 17.40000 | 1 |
| 470,000 | 41.040 × 10⁸ | 4.0800000 | 81.60000 | 1 |
| 1,000,000 | 1.858 × 10¹⁰ | 4.3400000 | 174.00000 | I_{θNnm} = 72 A; 2 |
| 2,000,000 | 7.432 × 10¹⁰ | 8.6700000 | 347.00000 | I_{θNnm} = 87 A; 4 |

The above results show that in controlled thermonuclear inertial confinement fusion as described above, the target may have a volume of 5 mm³ inside the solenoid 10, consistent with the findings in Subramaniam [9]. The size and shape of the solenoid may be selected for a given application. For example, if the solenoid is cylindrical and has a volume of 5 mm³, which is equal to 0.50×10⁻² cm³, then for a length of 1 cm, the diameter would be equal to 0.08 cm. Alternatively, for a solenoid with a diameter of 0.1 cm and a length of 1 cm, the volume is about 7.85 mm³.

For a magnetic field of 2 MT the compression of hydrogen ion molecules is approximately 15. In the presence of such a field, the 5 mm³ volume may be reduced to approximately 0.3 mm³. If the length of the compressed target is 5 mm, then the diameter is of the order of 0.3 mm, which is 1/33 the diameter of a solenoid 10 with a diameter of 10 mm. For a string of fuel material placed along the axis of such the solenoid 10 where the solenoid 10 is otherwise filled with a dielectric material (i.e. the body 12 and any additional material provided within the cavity 14), the target material would have little effect on the effective dielectric constant. Over such a small radius of the target fuel material, the B_{z} is approximately B_{z}(0). As already noted, as the eigenvalues increase, the frequency increases and \hat{ε}_{H}, I_{θN}, and λ decrease. In addition, as the eigenvalue increases, fewer concentric solenoids are necessary to achieve a given magnetic field density.

The solenoid energy stored, λ, the current flowing required and the number of nested solenoids needed may be optimized for a given application. The above modelling suggests that the hydrogen fuel molecules are compressed but that their form is preserved. Where the conductive material inside the conduction member 12 is assumed to provide a perfect conductor, the electric field is independent of the magnetic field. The electric field approaches zero on the inside. The magnetic field approaches zero on the outside surface of the conduction member 12. For material such as a fusion target on axis in the cavity, the electric field on axis is zero.

Solenoid Design

FIGS. 12 and 13 show a solenoid 210 in which the conduction member 212 includes a series of discs 230 connected by a conduction linker 232. The cavity 214 is defined within the conduction member 212. The cavity extends along the longitudinal axis 216. The inside radius 220 extends from the midpoint 221 of the solenoid 210 located along the longitudinal axis 216 to an inside surface of the conduction member 212. The outside radius 222 extends from the midpoint 221 to an outside surface of the conduction member 212.

The difference between the value of the outside radius 222 and the value of the inside radius 220 is equal to the thickness A of the conduction member 212 along the dimension extending radially with respect to the longitudinal axis 216. The conduction member 212 as a whole, and each of the plates 230, have a thickness A that is much greater along the dimension extending radially with respect to the longitudinal axis 216 than along the longitudinal axis. The plates 230 may be spaced from each other or otherwise insulated such that the only impulse communication is along the conduction linker 232, allowing the conduction member 212 to function as a solenoid.

Solenoid Applications

The solenoid 10, the solenoid 110, including in concentric arrangements, may be applied outside of applications to facilitating fusion. Miniaturized systems for information containing media, power circuits, transformers, or control systems may all benefit from highly concentrated magnetic fields in small volumes in a variety of fields. The solenoid could also be applied in material processing for increasing the stability of ionic species.

The solenoid could also be applied for greater miniaturization of sensors, motors, actuators, integration units, or other devices. In addition, while solenoids designed for higher magnetic field density values in the 10⁵ T and greater range may be required for facilitating fusion, other applications may benefit from magnetic field density values in the 10² to 10⁴ T. For such applications, the solenoids may be used with lower values of A and with other less stringent material requirements.

With the increased magnetic field density concentration and corresponding miniaturization that the solenoid facilitates, applications in designing miniaturized or nanoscale sensors, actuators, controls, motors, and miniaturized transformers, or other devices that have applications a variety of fields (e.g. medicine, transportation, power, electrical distribution and storage, information technology, etc.). The solenoid may facilitate reducing cost, size, and weight of transformers, vehicles, or other larger items.

With the magnetic fields of great density that this approach generates, one potential transportation applications could be in the use of high speed MAGLEV trains that require large magnetic fields. In medicine, miniaturization may facilitate lower-cost, smaller-footprint MRI and other diagnostic techniques.

### REFERENCES

[1] Canuto, V., Kelly, D. C. “Hydrogen Atom in Intense Magnetic Field”, Astrophysics and Space Science (1972) 17, 277-291.
[2] Aringazin, A. K. “Toroidal configuration of the orbit of the electron of the hydrogen atom under strong external magnetic fields”, Hadronic J. (2001) 24, 395-434.
[3] “McGill Online Magnetar Catalog”, online: http://www.physics.mcgill.ca/˜pulsar/magnetar/main.html. Retrieved Sep. 20, 2016 as modified Mar. 24, 2016.
[4] Biello, David. “High-Powered Lasers Delivery Fusion Energy Breakthrough”, Scientific American (2014).
[5] Hurricane, O. A. et al. “Fuel gain exceeding unity in an inertially confined fusion implosion”, Nature (2014) 506, 343-348.
[6] Francis Theo Y. C., “Status of the U.S. program in magneto-inertial fusion”, Journal of Physics (2008), Conference Series 112-042084.
[7] ITER—the way to new energy. https://www.iter.org/
[8] Sinars, Daniel. “Magnetized Linear Inertial Fusion on the 100-ns Z facility and prospects for a “breakeven” experiment.” Sandia National Laboratories ARPA-E Workshop. Oct. 29-30, (2013) Berkeley, Calif.
[9] Chandramouli Subramaniam, lakeo Yamada, Kazufumi Kobashi, Atzuko Sekiguchi, Don N. Futaba, Motoo Yumuza and Kenji Hata, “One hundred fold increase in current carrying capacity in a carbon nanotube-copper composite” Nature Communications (2013) 4, article number 2202.
[10] Online: https://en.wikipedia.org/wiki/Carbon_nanotube
[11] Donald L. Kreider, Robert S. Kuller, Donald R. Ostberg, Fred W. Perkins. “An Introduction to Linear Analysis”, (1966) Addison-Wesley (Canada) Limeted, Don Mills, Ontario, at p. 620.

### EXAMPLES ONLY

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A method of facilitating fusion comprising
providing a fuel comprising at least one fusion isotope;
applying a compressive magnetic field having a field strength of at least 10⁵ T to the fuel to compress the fuel, resulting in a compressed fuel having an increased electron binding energy of the fusion isotope by a factor of at least 1.04 and an increased molecular density of the fusion isotope by a factor of at least 1.14; and
applying a laser to the compressed fuel to excite the fusion isotope and transition the fuel to plasma, facilitating fusion between nuclei of the fusion isotope.

2. The method of claim 1 wherein the compressive magnetic field has a strength of at least 4.7×10⁵ T.

3. The method of claim 2 wherein the compressive magnetic field has a strength of at least 1×10⁶ T.

4. The method of claim 3 wherein the compressive magnetic field has a strength of about 2×10⁶ T.

5. The method of claim 1 wherein the at least one fusion isotope comprises at least one hydrogen isotope.

6. The method of claim 5 wherein the at least one hydrogen isotope comprises deuterium.

7. The method of claim 6 wherein the at least one hydrogen isotope comprises tritium.

8. The method of claim 1 wherein applying the compressive magnetic field takes place for between about 0.01 ns and about 10 ns.

9. The method of claim 1 wherein applying the laser takes place for about 10 ns.

10. The method of claim 1 wherein applying the compressive magnetic field continues after the onset of applying the laser to the fuel for confining the plasma.

11. The method of claim 1 wherein:
the at least one fusion isotope comprises deuterium;
the compressive magnetic field has a field strength of about 4.7×10⁵ T;
the increased electron binding energy is increased by a factor of about 1.4; and
the increased molecular density is increased by a factor of about 3.

12. The method of claim 11 wherein the at least one fusion isotope further comprises tritium.

13. The method of claim 1 wherein:
the at least one fusion isotope comprises deuterium;
the compressive magnetic field has a field strength of about 1×10⁶ T;
the increased electron binding energy is increased by a factor of about 1.8; and
the increased molecular density is increased by a factor of about 7.

14. The method of claim 11 wherein the at least one fusion isotope further comprises tritium.

15. The method of claim 1 wherein:
the at least one fusion isotope comprises deuterium;
the compressive magnetic field has a field strength of about 2×10⁶ T;
the increased electron binding energy is increased by a factor of about 2.4; and
the increased molecular density is increased by a factor of about 16.

16. The method of claim 11 wherein the at least one fusion isotope further comprises tritium.

17. The method of claim 1 wherein the compressed fuel has an electron radius on the order of 10⁻¹¹ m.

18. The method of claim 1 wherein the fuel comprises about 5 mm³ of solid deuterium contained in a first solenoid.

19. The method of claim 18 wherein the first solenoid comprises a conductive member coiled around the fuel for localizing the compressive magnetic field.

20. The method of claim 19 wherein the conductive member comprises a composite material, the composite material including a conductor material and a semiconductor material.

21. The method of claim 20 wherein the conductor material comprises a metal and the semiconductor material comprises carbon nanotubes.

22. The method of claim 21 wherein the metal comprises copper and the composite material comprises copper bonded on the carbon nanotubes.

23. The method of claim 18 further wherein
the first solenoid is received within a second solenoid;
each of the first solenoid and the second solenoid has a thickness extending radially with respect to a common longitudinal axis of the two solenoids, the thickness having a value of λ; and
the first solenoid is separated from the second solenoid by an integer value of λ.

24. A solenoid for enhancing a magnetic field within the solenoid, the solenoid comprising:
a conduction member extending along a longitudinal axis, the conduction member having a thickness extending radially with respect to the longitudinal axis, the thickness having a value of λ; and
a cavity defined within the conduction member, the cavity extending along the longitudinal axis for receiving a target material;
wherein the conduction member comprises a conductor material and a semi-conductor material for providing a highly conductive composite material.

25. The solenoid of claim 24 wherein the conduction member is coiled about the longitudinal axis.

26. The solenoid of claim 25 wherein the conduction member is coiled about the longitudinal axis in a helical pattern around the longitudinal axis.

27. The solenoid of claim 24 wherein the conduction member comprises a series of plates in communication with each other through a conduction linker.

28. The solenoid of claim 27 wherein the value of λ is at least 10 times greater than a dimension of the plates extending along the longitudinal axis.

29. The solenoid of claim 24 wherein the conductor material comprises copper, the semiconductor material comprises a forest of carbon nanotubes, and the composite material comprises copper bonded to the forest of carbon nanotubes.

30. The solenoid of claim 24 further comprising an insulative body within the conduction member, the insulative body electrically insulating the cavity from the conduction member.

31. The solenoid of claim 24 wherein, for a selected value of magnetic field density B_{z}(0),
$$λ = 1.989 {( 10 )}^{- 8} {J}_{0} ( ω \sqrt{μɛ} \frac{d}{2} ) {B}_{z} ( 0 ) .$$

32. A system comprising at least two concentrically arranged solenoids according to any of claims 24 to 31, the concentrically arranged conduction members share a common value of λ.

33. The system of claim 32 wherein neighbouring concentrically arranged conduction members are separated by a distance of nλ.
